(19) United States
(12) Patent Application Publication
(10) Pub. No.: US 2008/0008494 A1
(43) Pub. Date: Jan. 10, 2008

(54) Methods for imaging cartridge conversion

(75) Inventors: Thomas J. Martin, Sanford, NC (US); Donald R. Huck, Raleigh, NC (US)

Correspondence Address: WILLIAM L. LONDON, 3010 LEE AVENUE, P.O. BOX 152, SANFORD, NC, 27330, US

(73) Assignee: Static Control Components, Inc., Sanford, NC (US)

(21) Appl. No.: 11/481,124

(22) Filed: Jul. 5, 2006

(51) Int. Cl. G03G 15/00

(52) U.S. Cl. 399/109

(57) ABSTRACT

Techniques are provided for modifying a printer cartridge intended for installation in one type of printer to be installed in another type of printer or a plurality of printers. In one aspect, a method of modifying a toner cartridge may include modifying one or more end portion of the toner cartridge. In another aspect, a method of modifying a toner cartridge may include adding a patch on the converted cartridge.

### FIELD OF INVENTION

The present invention relates to remanufacturing and modifying imaging process cartridges, such as printer toner cartridges, and more particularly to techniques for modifying an imaging process cartridge intended to operate in one type or model of imaging device, such as a printer, to operate in additional types or models of imaging devices.

### BACKGROUND

Printer cartridges are typically designed to provide the consumer a certain number of print copies before the toner or ink is exhausted. The total number of prints varies depending on the type, quality and density of the print provided by the printer. After all of the toner or ink is spent, the cartridges are either thrown away or recycled.

An emerging industry has developed that deals with the recycling of printer cartridges. Typically, the cartridge is recycled by a cartridge remanufacturer, who receives spent printer cartridges and refurbishes them. The refurbishment process entails replacing the worn or nonfunctioning parts, refilling the cartridge with either toner or ink, and distributing the refurbished cartridges into the marketplace.

Toner cartridges are typically designed to fit into one type of laser printer or family of laser printers. For example, the same toner cartridge may be used in an HP4200 or HP4300 monochrome laser printer. As new printer models are introduced, the printer manufacturer may decide to alter the physical characteristics of the printer cartridge. In some cases the alteration may be an entirely new shape or the printer manufacturer may only change a minor detail such as an indentation or a protrusion on the cartridge.

A typical toner cartridge comprises an assembled plastic housing. The material of the housing may be molded plastic or other plastic composite. During the remanufacturing of the cartridge, the cartridge is disassembled, cleaned, refurbished and reassembled. The last step of the refurbishment process typically includes refilling the cartridge with toner and repackaging of the cartridge. As part of the refurbishment process, the toner cartridges may be modified in order to remove any restriction regarding usage.

The present invention converts a printer imaging cartridge such as a laser toner cartridge for use in one type of printer to be usable in another type of printer by removing a protrusion and a horizontal edge from an end portion of the toner cartridge. In another embodiment of the present invention, a rib is removed from an end portion of another type of toner cartridge, allowing the modified toner cartridge to be used in another type of printer.

### SUMMARY

A method of modifying an imaging process cartridge, the imaging process cartridge installable in a first imaging device and not installable in a second imaging device, the method comprising, providing the imaging process cartridge, said imaging process cartridge comprising a contact side end portion, said contact side end portion further comprising a lower vertical surface extending from a first end to a mid point of said end portion, wherein a protrusion is mounted on said lower vertical surface and extends perpendicularly away from said lower vertical surface, and an upper vertical surface extending from said midpoint to a second end of said contact side end portion, removing a portion of said protrusion, and removing a section of said upper vertical surface to form a modified imaging process cartridge is installable in said second imaging device.

A method of modifying an imaging process cartridge, the imaging process cartridge installable in a first imaging device and not installable in a second imaging device, the method comprising, providing the imaging process cartridge, said imaging process cartridge comprising a gear side end portion, said gear side end portion further comprising an upper vertical surface and a lower vertical surface, said lower vertical surface extending from a first end of said gear side end portion to about a midpoint of said gear side end portion, said upper vertical surface extending from said midpoint towards a second end of said gear side end portion, said gear side end portion further comprising an upper rib, a lower rib, a left connecting rib, a middle connecting rib and a right connecting rib mounted on said gear side end portion, said upper and lower ribs extending across said lower vertical surface and across a section of said upper vertical surface, said left connecting rib and said middle connecting rib located on said upper vertical surface and said right connecting rib located on said lower vertical surface, said upper, lower and connecting ribs protruding perpendicularly away from said lower vertical surface and said upper vertical surface, removing said upper rib, said left connecting rib, said middle connecting rib, and a part of said right connecting rib, and reducing said lower rib and said remaining right connecting rib in height to form a modified imaging process cartridge, wherein said lower rib and said remaining right connecting rib are about equal in height with said upper vertical surface, said modified imaging process cartridge installable in said second imaging device.

A method of modifying an imaging process cartridge, the imaging process cartridge installable in a first imaging device and not installable in a second imaging device, the method comprising, providing the imaging process cartridge, said imaging process cartridge comprising a gear side end portion, said gear side end portion further comprising an upper vertical surface and a lower vertical surface, said lower vertical surface extending from a first end of said gear side end portion to about a midpoint of said gear side end portion, said upper vertical surface extending from said midpoint towards a second end of said gear side end portion, said gear side end portion further comprising an upper rib, a lower rib, a left connecting rib, a middle connecting rib and a right connecting rib mounted on said gear side end portion, said upper and lower ribs extending across said lower vertical surface and across a section of said upper vertical surface, said left connecting rib and said middle connecting rib located on said upper vertical surface and said right connecting rib located on said lower vertical surface, said upper, lower and connecting ribs protruding perpendicularly away from said lower vertical surface and said upper vertical surface, removing said upper rib, said left connecting rib, said middle connecting rib, and said right connecting rib, and reducing in height said lower rib to form a modified imaging process cartridge, wherein said lower rib is about equal in height with said upper vertical surface, said modified imaging process cartridge is installable in said second imaging device.

A more complete understanding of the present invention, as well as further features and advantages of the invention, will be apparent from the following detailed description and the accompanying drawings.

### BRIEF DESCRIPTION OF THE DRAWINGS

FIG. 1 shows a front perspective view of a prior art HP4730 toner cartridge.

FIG. 2 shows an exploded front perspective view of the HP4730 toner cartridge, with the toner hopper removed.

FIG. 3A shows a side perspective view of a contact side end portion the cartridge of FIG. 1.

FIG. 3B shows a side view of the end portion of FIG. 3A.

FIG. 3C shows a top view of the end portion of FIG. 3A.

FIG. 4A shows a side perspective view of a contact side end portion of a prior art HP4700 printer cartridge.

FIG. 4B shows a side view of the end portion of FIG. 4A.

FIG. 4C shows a top view of the end portion of FIG. 4A.

FIG. 5A shows a side perspective view of a contact side end portion in accordance with one embodiment of the present invention.

FIG. 5B shows a side view of the end portion of FIG. 5A.

FIG. 5C shows a top view of the end portion of FIG. 5A.

FIG. 6A shows a side perspective view of a gear side end portion of the cartridge of FIG. 1.

FIG. 6B shows a side view of the end portion of FIG. 6A.

FIG. 7A shows a side perspective view of a gear side end portion of the HP4700 printer cartridge.

FIG. 7B shows a side view of the end portion of FIG. 7A.

FIG. 8A shows a side perspective view of a gear side end portion in accordance with one embodiment of the present invention.

FIG. 8B shows a side view of the end portion of FIG. 8A.

### DETAILED DESCRIPTION

The following detailed description of preferred embodiments refers to the accompanying drawings, which illustrate specific embodiments of the invention. In the discussion that follows, specific systems and techniques for repairing, manufacturing or remanufacturing an imaging cartridge, such as a toner cartridge are used as examples. Other embodiments having different structures and operations for the repair, remanufacture and operation of other types of replaceable imaging components and for various types of imaging devices, such as laser printers, inkjet printers, copiers, facsimile machines and the like, do not depart from the scope of the present invention.

Within the printer industry, printer manufacturers have employed various techniques to differentiate between toner cartridges used in different printers. These techniques range from the obvious altering of the physical dimensions and shape of the toner cartridge or imaging drum unit to very subtle indentations or protrusions positioned at certain locations on the toner cartridge or imaging drum unit. For example, some printer manufacturers have installed protrusions such as fins or keys that extend out from the printer's toner cartridge compartment and are positioned inside a recess on the toner cartridge when the toner cartridge is installed inside the printer. In other printer types this arrangement may be reversed. The key may exist on the toner cartridge, and the recess may exist inside the toner cartridge compartment inside the printer.

As new printer models are developed, “new” toner cartridges may also be introduced. In some cases, the new toner cartridge may contain exactly the same components as those of the previous printer model. However, the new toner cartridge or imaging drum unit may have slightly different physical packaging. In some cases, the printer manufacturer may install different keys, or keys in different locations. Changing the size, shape, orientation or location of the keys allows the printer manufacturer to differentiate between a previously introduced toner cartridges and those of newer models. This may allow the printer manufacturer to increase his margins by charging the consumer a premium for the new cartridge.

Printer manufacturers may take advantage of existing toner cartridge technology by using an existing toner cartridge design and making only slight physical packaging modifications. For example, the black toner cartridge for the HP4700 color laser printer may have exactly the same internal components and even use the same toner as the black toner cartridge for the HP4730 color laser printer. In this case, the only packaging difference between the toner cartridges is the shape of the end portions on the waste bin of the cartridges. Additionally, within the same printer, the cartridges may be physically identical with the exception of the color toner installed in the cartridge.

In the toner cartridge refurbishment industry, the used toner cartridges are collected and serviced by toner cartridge remanufacturers. The first step in the refurbishment process is the disassembling of the spent cartridges. Next, the internal components are separated. Non-functioning components are replaced, and the remaining components, as well as the body of the device undergo a cleaning process. In the final step the device is reassembled and new toner is added to the toner cartridge. The refurbished device is then packaged and distributed to the consumer.

Part of the refurbishment process may include making physical alterations to the toner cartridge. For example, older cartridges may be altered or converted for use in other printer types. Alternatively, the remanufacturer may remove all of the physical restrictions from the toner cartridge, thus creating a “universal” cartridge that may be used in across multiple printers. The present invention provides a way of converting a printer toner cartridge of one type into one useable in another type of printer.

As is discussed in greater detail in subsequent sections, a toner cartridge used in the HP4700 color laser printer is not physically compatible in the HP4730 color laser printer due to physical differences between the cartridges. Similarly, toner cartridges used in the HP4730 color laser printer are not compatible for use in the HP4700 color laser printer.

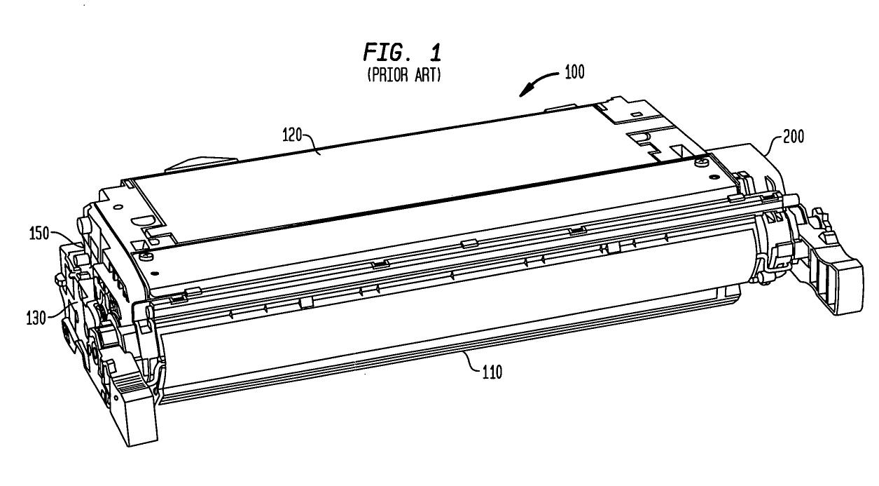

FIG. 1 shows a front perspective view of a prior art toner cartridge 100 used in the HP4730 color laser printer. The cartridge 100 may be installed in any of the toner cartridge locations within the HP4730 color laser printer (black, cyan, magenta or yellow), depending on the color of toner contained in the cartridge 100. Cartridge 100 comprises a toner hopper assembly 110 and a waste bin assembly 120. On the ends of the cartridge 100 are a cartridge gear side end portion 200 as well as a toner hopper contact side end portion 130, and a waste bin assembly contact side end portion 150. During the remanufacturing process, the hopper assembly 110 and the waste bin assembly 120 are separated.

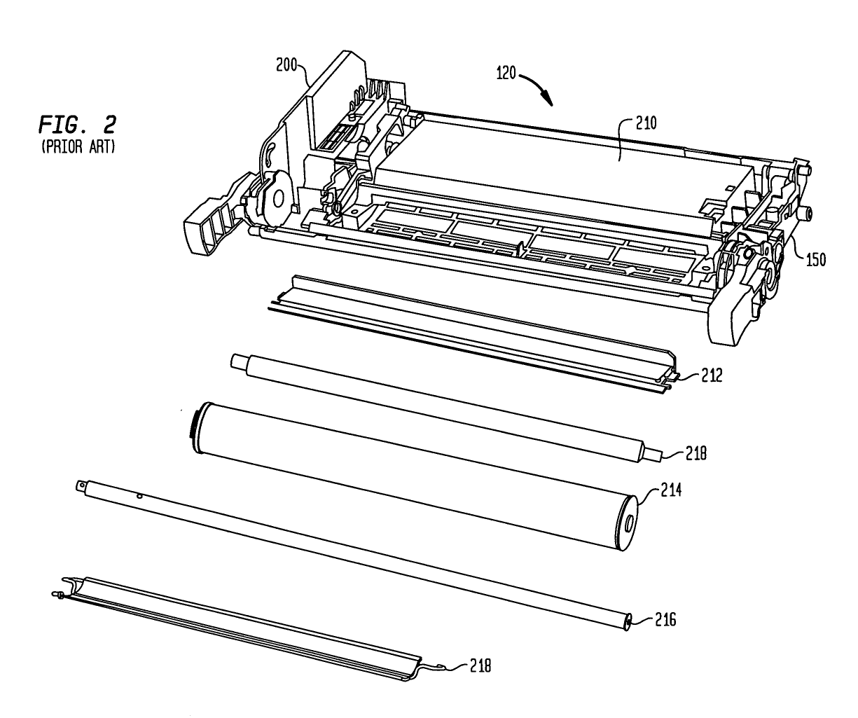

FIG. 2 displays a front perspective exploded view of the waste bin assembly 120 with the toner hopper assembly 110 removed. The waste bin assembly 120 comprises a wiper blade 212 that removes any excess toner off of the OPC (Organic Photo Conductor) drum 214 into the waste bin 210 during the printing process. A drum shaft 216 is inserted into the OPC drum 214 allowing the drum to rotate. A PCR 218 (Primary Charge Roller) provides the OPC drum 214 with a uniform charge. Protecting the OPC drum 214 and other internal components is a drum shutter 218. Those skilled in the art appreciate that during the laser printing process, the printer applies a laser which statically charges the OPC drum 214 with an appropriate charge corresponding to the image the printer is printing. The OPC drum 214 then collects toner from the toner hopper 110 which is then applied to the print media. After the toner is transferred to the printing media, the toner is fused onto the print media by a fuser assembly (not shown).

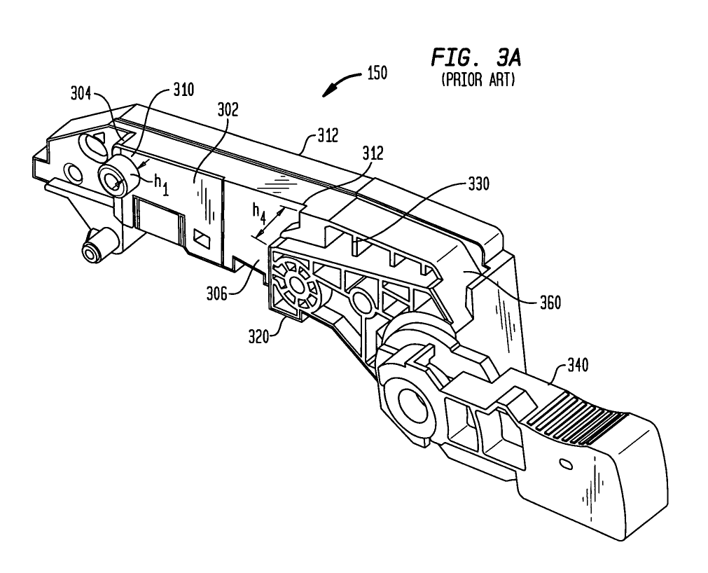

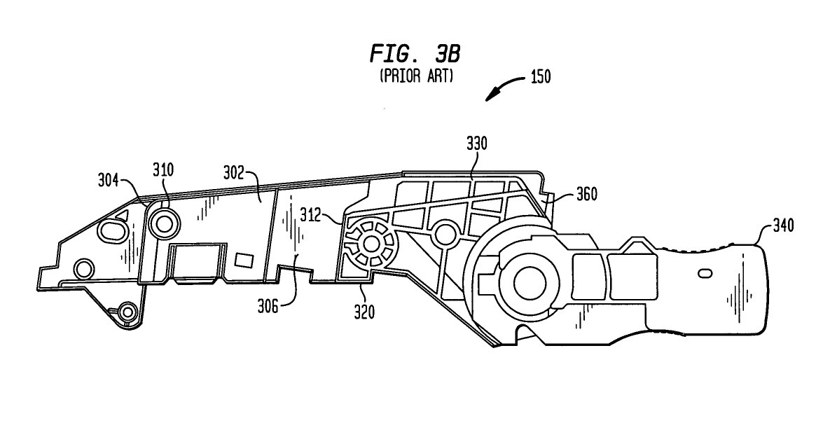

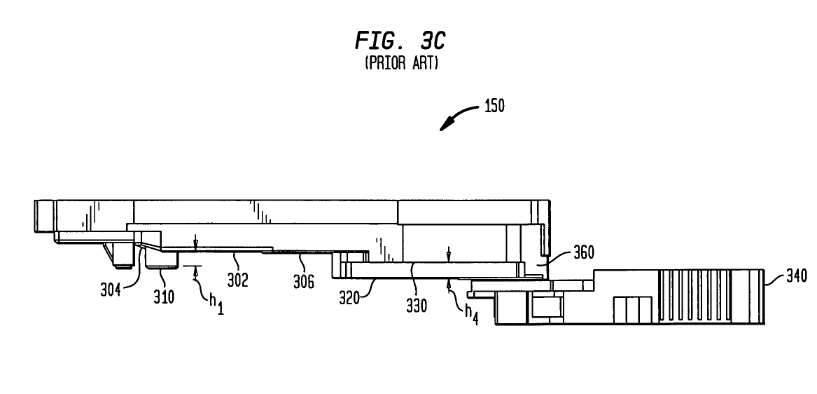

The HP4700 color toner cartridges are not compatible in the HP4730 color laser printers due to physical differences in the waste bin assembly contact side end portion 150. FIG. 3A displays a side perspective view of the waste bin assembly contact side end portion 150 for the HP4730 color laser printer. During the typical refurbishment process, the waste bin assembly contact side end portion 150 is not removed from the cartridge 100 because the waste bin assembly contact side end portion 150 is molded together with the waste bin assembly 120. The waste bin assembly contact side end portion 150 is shown separated for illustrative purposes.

As can be seen in FIG. 3A, the waste bin assembly contact side end portion 150 has a protrusion 310 located at a first end 304 of a first lower vertical surface 302. The protrusion 310 extends perpendicularly away from the lower vertical surface 302 by a height h₁. The protrusion 310 aligns with a recess located in the printer cartridge location within the HP4730 color laser printer. The first lower vertical surface 302 connects to a second lower vertical surface 306. The first lower vertical surface 302 and the second lower vertical surface 306 extend from about the first end point 304 to about a midpoint 312 of the waste bin assembly contact side end portion 150. FIGS. 3B and 3C display a side view and a top view of the waste bin assembly contact side end portion 150 respectively.

The waste bin assembly contact side end portion 150 also has a first upper vertical surface 320 and a second upper vertical surface 330 which extend from about the mid point 312 to about a second end point 360. As shown can best be seen in FIG. 3C, a height difference h₄ exists between the first upper vertical surface 320 and the second upper vertical surface 330. In the embodiment shown in FIGS. 3A-C, the second end point 360 is located at the handle end 340 of the waste bin assembly contact side end portion 150.

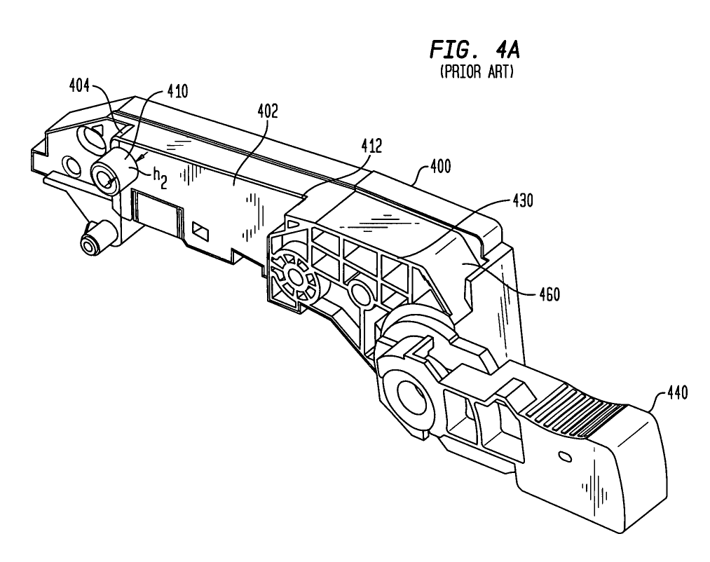

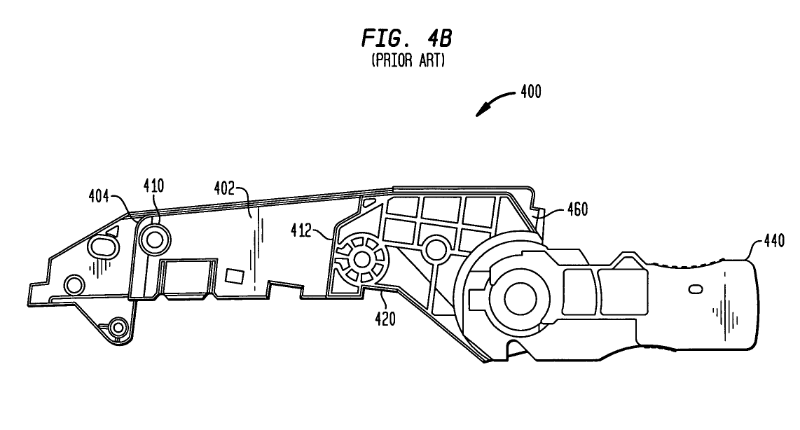

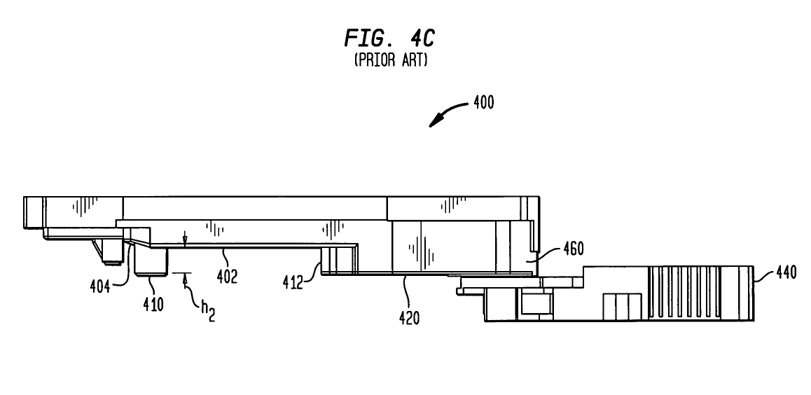

As shown in FIGS. 4A-C, the waste bin assembly contact side end portion 400 for the HP4700 has some slight physical differences. The waste bin assembly contact side end portion 400 has a slightly taller protrusion 410 when compared to the waste bin assembly contact side end portion 150 (FIGS. 3A-C). The difference between protrusion 410 and protrusion 310 is h₂-h₁. Protrusion 410 is located at a first end 404 on a lower vertical surface 402 that extends from the first end 404 to about a mid point 412. The protrusion 410 is mounted on the lower vertical surface 402 at about the same location as protrusion 310 is located on the first lower vertical surface 304.

In contrast to the waste bin assembly contact side end portion 150, the waste bin assembly contact side end portion 400 only has an upper vertical surface 420 that extends from about the mid point 412 to a second end point 460. The combination of the height differential of the protrusions h₂-h₁, as well as the lack of a second upper vertical surface 330 prevents the HP4700 toner cartridges from being used in the HP4730 color laser printer.

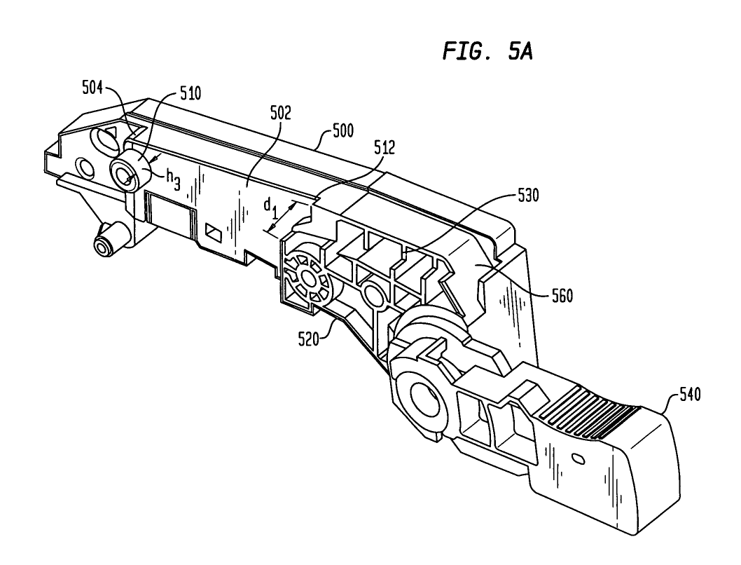

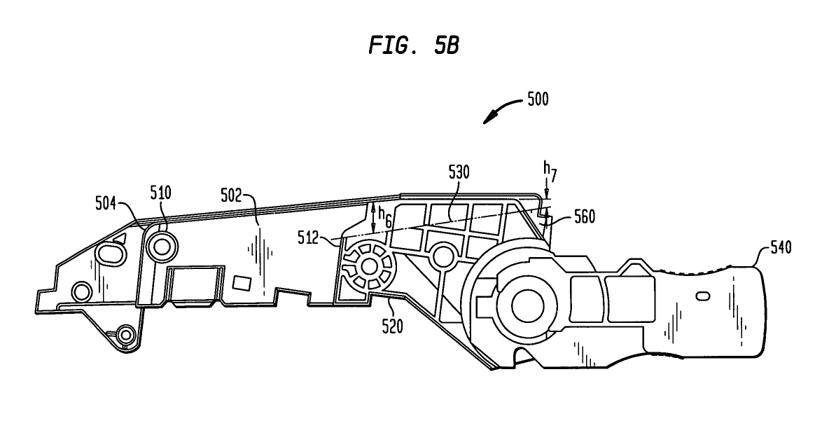

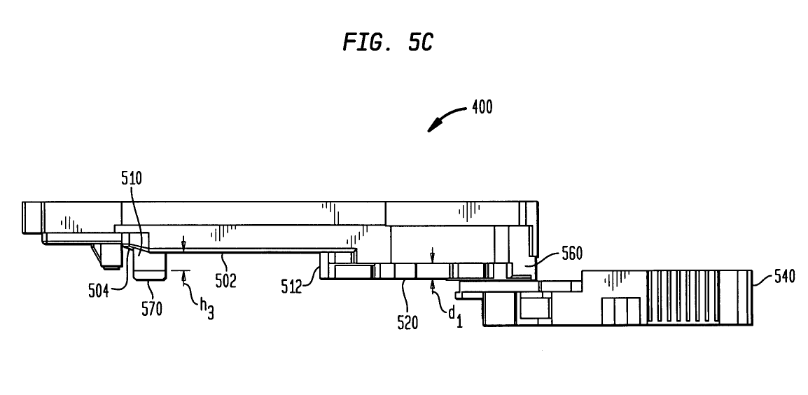

In accordance with one embodiment of the present invention, an HP4700 toner cartridge may be modified in order to be compatible with the HP4730 color laser printer as shown in FIGS. 5A-C. FIGS. 5A-C illustrate a waste bin assembly contact side end portion 400 that has undergone the conversion process as described hereinafter. The converted waste bin assembly contact side end portion 500 comprises a first upper vertical surface 520 and a second upper vertical surface 530 similar to the waste bin assembly contact side end portion 150 (FIGS. 3A-C). The converted waste bin assembly contact side end portion 500 also comprises a protrusion 510 of height h₃ located at a first end 504 on a lower vertical surface 502. Lower vertical surface 502 extends from the first end 504 to about a mid point 512.

As part of the conversion process, the height h₂ of the protrusion 410 is reduced be removing a portion 570 (shown as a dashed profile in FIG. 5C) of protrusion 410. The height h₃of protrusion 510 is about equal to height h₁ of protrusion 310. Portion 570 may be removed using any type of cutting device. For example a hack saw, file, band saw, jig saw, Rotozip™, Dremmel™ or other similar tool may be utilized. Although not recommended, the portion 570 may be removed by melting the protrusion 410. Typically, the portion 570 is approximately 0.1″ (2.54 mm) in height. Once the protrusion 510 has been modified, a file or other type of tool may be used in order to smooth out any rough surfaces left over from the conversion process.

The next step in converting the waste bin assembly contact side end portion 400 in accordance with the preferred embodiment includes removing a section of the upper vertical surface 420. As represented by the dashed profile in FIG. 5B, the section removed extends from about the mid point 512 to about the second end point 560. The depth of the section removed (difference between the first upper vertical surface 520 and the second upper vertical surface 530) is height d₁. Typically the depth d₁ is about 0.2″ (5.08 mm). The section has a front height h₆ of about 0.3″ (7.62 mm) and a rear height h₇ of about 0.2″ (5.08 mm). Once the section has been removed, a file or other type of tool may be used in order to smooth out any rough surfaces left over from the conversion process.

In yet another alternative embodiment of the present invention, a patch may be inserted where the section has been removed in order to provide a more aesthetically appealing converted waste bin assembly contact side end portion 500

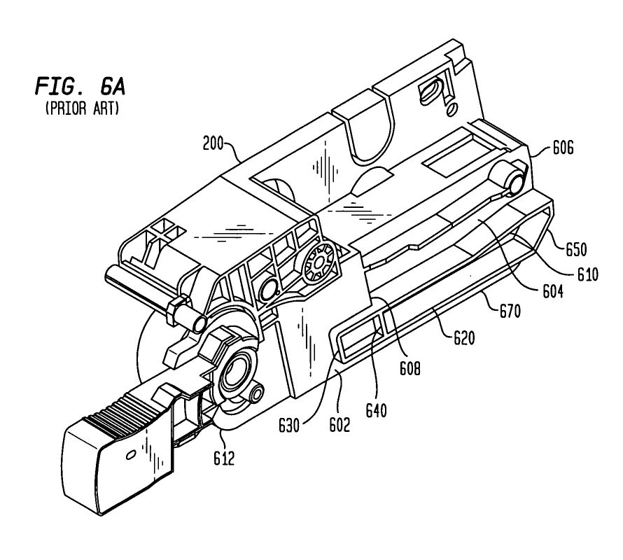

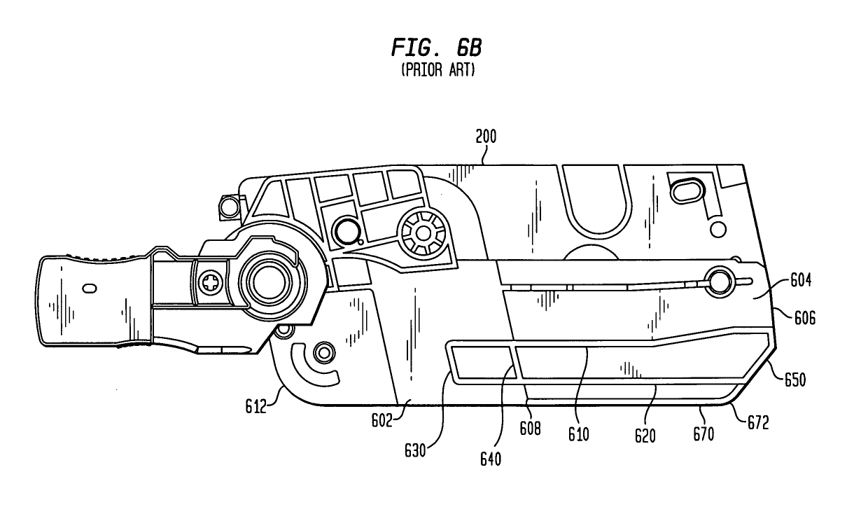

In another embodiment of the present invention, an HP4730 waste bin assembly may be converted to be usable in an HP4700 color laser printer. FIG. 6A displays a side perspective view of cartridge gear side end portion 200 of the HP4730 toner cartridge 100. FIG. 6B displays a side view of cartridge gear side end portion 200. The cartridge gear side end portion 200 comprises an upper vertical surface 602 and a lower vertical surface as well as an upper rib 610 and a lower rib 620. The lower vertical surface 604 extends from a first end 606 to about a mid point 608. The upper vertical surface 602 extends from the mid point 608 to point about half way between the mid point 608 and a second end 612. The upper rib 610 and lower rib 620 extend across the lower vertical surface604 and across part of the upper vertical surface 602. Connecting the upper rib 610 to the lower rib are a left connecting rib 630, a middle connecting rib 640 and a right connecting rib 650. Left connecting rib 630 and middle connecting rib 640 are located on the upper vertical surface 602 while right connecting rib 650 is located on the lower vertical surface 604. The ribs (610, 620, 630, 640 and 650) are about equal in height and protrude away from the upper vertical surface 602 by approximately 0.1″ (2.54 mm)

Cartridge gear side end portion 200 also has a bottom rib 670 and a bottom connecting rib 672. The bottom connecting rib 672 extends from the juncture of the lower rib 620 and the right connecting rib 650 to the bottom rib 670. Bottom rib 670 extends from the bottom connecting rib 672 to mid point 608. Unlike the other ribs (610, 620, 630, 640 and 650) bottom rib 670 and bottom connecting rib 672 are planarlly parallel with upper vertical surface 602 and thus do not extend beyond upper vertical surface 602.

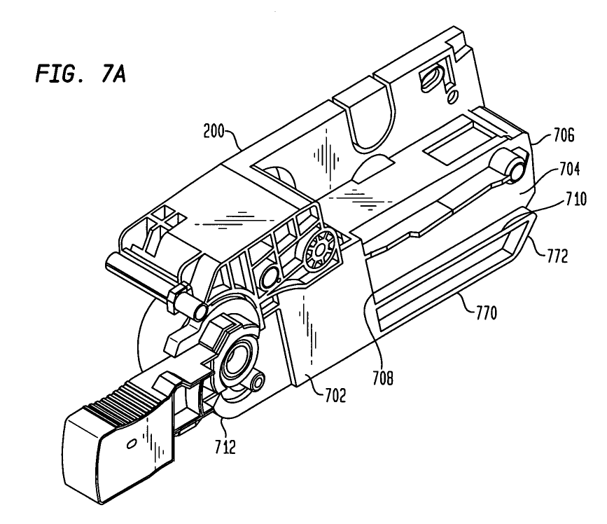

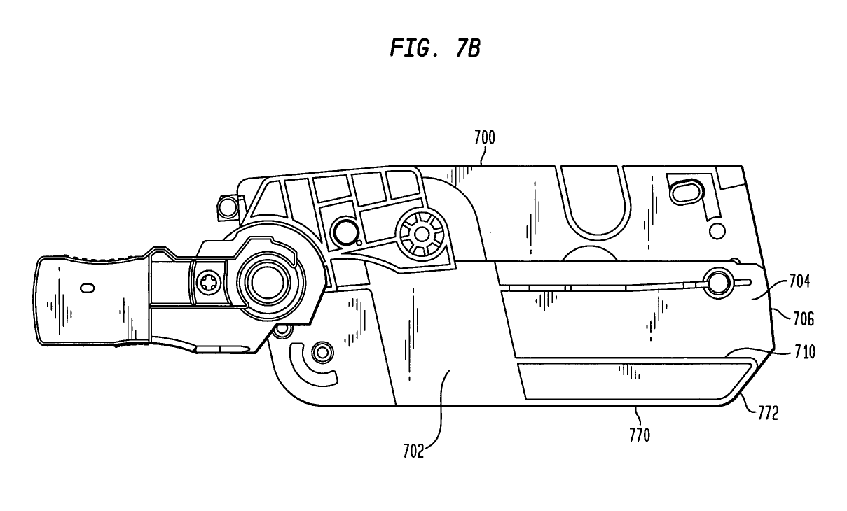

FIGS. 7A and 7B illustrate a side perspective and side view respectively of a cartridge gear side end portion 700 of the HP4700 toner cartridge. Similar to cartridge gear side end portion 200, cartridge gear side end portion 700 also has an upper vertical surface 702 and a lower vertical surface 704 as well as a bottom rib 770, a bottom connecting rib 772 and a lower rib 710 mounted on lower vertical surface 704. Lower vertical surface extends from a first end 706 to about a mid point 708. Upper vertical surface 702 extends from the mid point 708 to point about half way between the mid point 708 and a second end 712. Like bottom rib 670 and bottom connecting rib 672 (FIGS. 6A & B), bottom connecting rib 772 and lower rib 710 are planarlly parallel with upper vertical surface 702 and thus do not extend beyond upper vertical surface 702.

When comparing cartridge gear side end portion 200 with cartridge gear side end portion 700, the physical differences of ribs (610, 620, 630, 640 and 650) are apparent. Within the HP4700 color laser printer, there is no recess corresponding to ribs 610, 620, 630, 640 and 650. Therefore, if toner cartridge 100 (intended for use in the HP4730 color laser printer) were to be inserted into the HP4700 color laser printer, the ribs would restrict the cartridge from being fully inserted into the toner cartridge compartment (not shown).

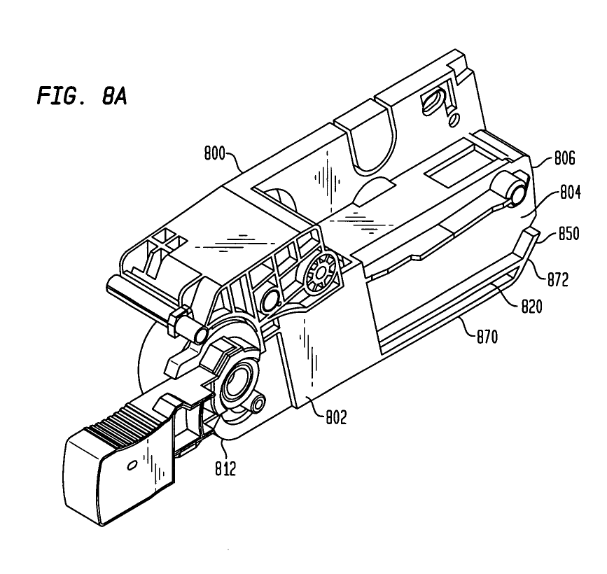

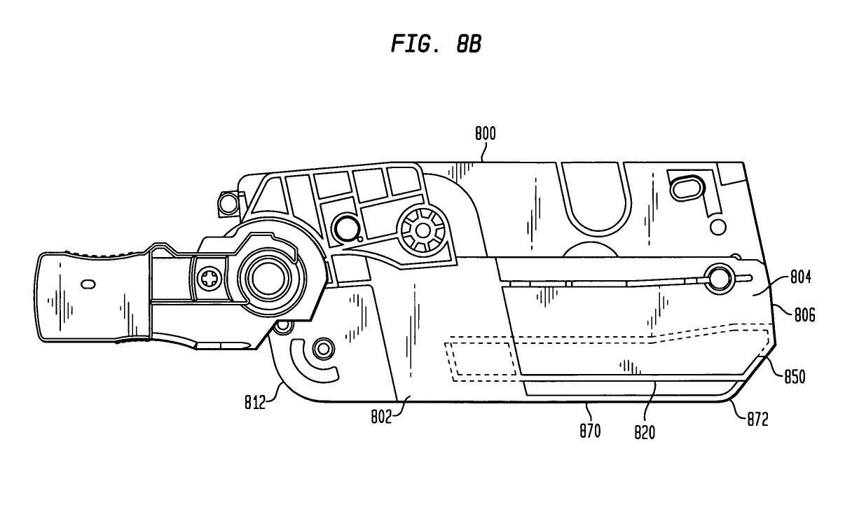

In accordance with another embodiment of the present invention, toner cartridge 100 may be modified in order to allow the modified toner cartridge 800 to be used in other types of printers as shown in FIGS. 8A and B. FIG. 8A illustrates a side perspective view of a modified cartridge gear side end portion 800. FIG. 8B displays a side view of modified cartridge gear side end portion 800.

As can be seen in FIGS. 8A & B, the upper rib 610 of cartridge gear side end portion 200 has been removed entirely. In addition, left connecting rib 630, middle connecting rib 640 and a part of right connecting rib 650 have also been removed (as shown outlined by the dashed lines). The height of lower rib 820 and remaining right connecting rib 850 are reduced so that they are roughly planarlly parallel with upper vertical surface 802 and thus do not extend beyond upper vertical surface 802.

One way of removing the upper rib 610, left connecting rib 630, middle connecting rib 640 and a part of right connecting rib 650 is to use a hack saw, band saw, jig saw, RotoZip™, Dremmel™ or other similar tool. Although not recommended, the ribs 610, 620, 640, and 650 may be melted down as well. In addition to removing ribs 610, 620, 640, and 650, the remaining ribs that protrude above the upper vertical surface 802 (lower rib 820 and right connecting rib 850) may be reduced in height the same tool used to remove the other ribs (610, 620, 640, and 650). Once the ribs (610, 620, 640, and 650) have been removed and the remaining ribs (820, 850) have been reduced in height, a file or other type of tool may be used in order to smooth out any rough surfaces left over from the conversion process. In yet another embodiment of the present invention, the right connecting rib 850 may be removed completely.

A waste bin assembly 120 comprising the converted waste bin assembly contact side end portion 500 (FIGS. 5A-C) and cartridge gear side end portion 700 (FIGS. 7A & B) allows the toner cartridge 100 to be used universally in either the HP4700 or HP4730 color laser printers. Similarly, a waste bin assembly 120 comprising the converted gear side end portion 800 (FIGS. 8A & B) used with a waste bin assembly contact side end portion 300 (FIGS. 5A-C) allows the toner cartridge to be used universally in either the HP4700 or HP4730 color laser printers.

Within the toner cartridge or imaging drum unit, an electronic identification chip may be installed. The identification chip may contain information relating to the printer type, printer manufacturer, amount of toner contained in the toner cartridge and so forth. Even if the physical restrictions between cartridge types have been removed, the electronic identification chip may need to be replaced with a compatible electronic chip in order to allow the toner cartridge or imaging drum unit to function properly in its new location or printer.

Although specific embodiments have been illustrated and described herein, those of ordinary skill in the art appreciate that any arrangement, which is calculated to achieve the same purpose, may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method of modifying an imaging process cartridge, the imaging process cartridge installable in a first imaging device and not installable in a second imaging device, the method comprising:
providing the imaging process cartridge, said imaging process cartridge comprising a contact side end portion, said contact side end portion further comprising a lower vertical surface extending from a first end to a mid point of said end portion, wherein a protrusion is mounted on said lower vertical surface and extends perpendicularly away from said lower vertical surface, and an upper vertical surface extending from said midpoint to a second end of said contact side end portion,
removing a portion of said protrusion; and,
removing a section of said upper vertical surface to form a modified imaging process cartridge installable in said second imaging device.

2. The method of claim 1 wherein said protrusion is cylindrical.

3. The method of claim 1 wherein said second end of said contact side end portion is a handle side.

4. The method of claim 1 wherein said upper vertical surface comprises a catacomb structure.

5. The method of claim 1 further comprising the step of attaching a patch to said contact side end portion where said section of said upper vertical surface was removed.

6. The method of claim 1 wherein said modified process cartridge is installable in an HP4730 color laser printer.

7. A method of modifying an imaging process cartridge, the imaging process cartridge installable in a first imaging device and not installable in a second imaging device, the method comprising:
providing the imaging process cartridge, said imaging process cartridge comprising a gear side end portion, said gear side end portion further comprising an upper vertical surface and a lower vertical surface, said lower vertical surface extending from a first end of said gear side end portion to about a midpoint of said gear side end portion, said upper vertical surface extending from said midpoint towards a second end of said gear side end portion, said gear side end portion further comprising an upper rib, a lower rib, a left connecting rib, a middle connecting rib and a right connecting rib mounted on said gear side end portion, said upper and lower ribs extending across said lower vertical surface and across a section of said upper vertical surface, said left connecting rib and said middle connecting rib located on said upper vertical surface and said right connecting rib located on said lower vertical surface, said upper, lower and connecting ribs protruding perpendicularly away from said lower vertical surface and said upper vertical surface,
removing said upper rib, said left connecting rib, said middle connecting rib, and a part of said right connecting rib; and,
reducing said lower rib and said remaining right connecting rib in height to form a modified imaging process cartridge, wherein said lower rib and said remaining right connecting rib are about equal in height with said upper vertical surface, said modified imaging process cartridge installable in said second imaging device.

8. The method of claim 7 wherein said second end of said end portion is a handle side end.

9. The method of claim 7 wherein said modified process cartridge is installable in an HP 4700 color laser printer

10. A method of modifying an imaging process cartridge, the imaging process cartridge installable in a first imaging device and not installable in a second imaging device, the method comprising:
providing the imaging process cartridge, said imaging process cartridge comprising a gear side end portion, said gear side end portion further comprising an upper vertical surface and a lower vertical surface, said lower vertical surface extending from a first end of said gear side end portion to about a midpoint of said gear side end portion, said upper vertical surface extending from said midpoint towards a second end of said gear side end portion, said gear side end portion further comprising an upper rib, a lower rib, a left connecting rib, a middle connecting rib and a right connecting rib mounted on said gear side end portion, said upper and lower ribs extending across said lower vertical surface and across a section of said upper vertical surface, said left connecting rib and said middle connecting rib located on said upper vertical surface and said right connecting rib located on said lower vertical surface, said upper, lower and connecting ribs protruding perpendicularly away from said lower vertical surface and said upper vertical surface,
removing said upper rib, said left connecting rib, said middle connecting rib, and said right connecting rib; and,
reducing in height said lower rib to form a modified imaging process cartridge, wherein said lower rib is about equal in height with said upper vertical surface, said modified imaging process cartridge is installable in said second imaging device.

11. The method of claim 10 wherein said second end of said end portion is a handle side end.

12. The method of claim 10 wherein said modified imaging process cartridge is installable in an HP 4700 color laser printer
